(19) United States
(12) Patent Application Publication
(10) Pub. No.: US 2026/0152031 A1
(43) Pub. Date: Jun. 4, 2026

(54) SUSPENSION SYSTEM, TOWED VEHICLE PROVIDED WITH SUCH A SYSTEM, ASSEMBLY KIT AND CORRESPONDING METHODS FOR ASSEMBLY, OPERATION AND USE

(71) Applicant: GEA FARM TECHNOLOGIES CANADA INC., Drummondville (CA)

(72) Inventors: Alain Courtemanche, Drummondville (CA); Yann Desrochers, Drummondville (CA)

(21) Appl. No.: 19/122,241

(22) PCT Filed: Oct. 19, 2023
(86) PCT No.: PCT/CA2023/051388

§ 371 Date: Apr. 17, 2025

(30) Foreign Application Priority Data
Oct. 19, 2022 (CA) 3179618

(51) Int. Cl. B60G 17/015; B60D 1/145; B60D 1/36; B60G 17/016

(52) U.S. Cl. CPC B60G 17/0152; B60D 1/145; B60D 1/36; B60G 17/016; B60G 2202/413; B60G 2300/04

(57) ABSTRACT

A displacement system for a towed vehicle intended to be pulled by a traction vehicle, the displacement system comprising: a series of front wheels adapted to be mounted on a front section of a chassis of the towed vehicle; a series of rear wheels adapted to be mounted on a subsequent section of the chassis of the towed vehicle; a movable drawbar adapted to be pivotably mounted relative to the chassis of the towed vehicle, and adapted to pivot about at least one corresponding axis of rotation, the drawbar being connectable to a hitch bar of the traction vehicle via a hitch device; and a drive device for displacing the corresponding axis of rotation of the drawbar relative to the chassis of the towed vehicle, in response to a given displacement surface.

### TECHNICAL FIELD

The present invention relates to the field of suspension devices for multi-axle trailers, such as those used in towing and/or agricultural applications and/or any other related types of applications. More specifically, the present invention concerns a new movement system (e.g., which may function as a suspension system, etc.) for a towed vehicle (e.g., a trailer, a spreader, etc.) intended to be pulled by a towing vehicle (e.g., a tractor, etc.), and also relates to a vehicle (e.g., a towing vehicle and/or a towed vehicle) and/or an arrangement of such vehicles equipped with such equipment, as well as a kit designed for assembling them, and corresponding methods of assembly, operation and/or use.

### BACKGROUND

It is known in the art that a coupling between an agricultural tractor and a towed equipment is carried out on the tractor's drawbar, and that the towed equipment must be able to follow the tractor's path and adapt to the terrain topology over which it is towed using a suspension system.

Traditionally, trailers (and/or spreaders) are constructed with a drawbar rigidly connected to the load-bearing structure of the trailer, and the other end of the drawbar is connected to the tractor's drawbar via a hitch that allows movement in all directions. In such a setup, only the trailer's axles are mounted on a suspension system in order to absorb shocks and adapt to the ground. Suspension systems can vary in type (regardless of the type of axle used), most notably ‘mechanical’ (e.g., ‘tandem’) or ‘hydraulic’, to name just a few.

The issue encountered with these setups is that the ability to adapt to the ground topology is limited. Indeed, depending on the trailer's length and axle configuration, variations in the terrain over which the trailer is towed may cause the front axle or axles of the trailer to lose contact with the ground, resulting in the towed weight being supported only by the trailer's rear axle and the tractor's drawbar. In such a situation, the load distribution may exceed the permissible limits of the trailer and tractor components, significantly increasing the risk of equipment failure and/or loss of control of the equipment.

Also known in the art is the connection of a hydraulic suspension system. Indeed, regardless of the number of axles used to support and distribute the trailer's load, the principle of communicating vessels is applied, and each hydraulic cylinder is connected in series on the piston side. Thus, when one of the axles moves, the oil volume shifts to the other cylinders, causing opposite-direction movements to keep the wheels in contact with the ground, while pressure remains evenly distributed throughout the hydraulic system. However, and unfortunately, this solution does not address the aforementioned problem.

Also known in the art is the management of the weight of spreading equipment (e.g., spreading booms, discs, etc.) which is generally located at the rear of the spreader. Indeed, this equipment can represent a significant load at the rear of the spreader, and this becomes a challenge when the quantity of liquid manure in the spreader decreases. Situations may arise where the weight transferred to the tractor's drawbar is ‘zero’ or even ‘negative’ in the worst cases (by ‘negative weight’, it is meant that the load on the tractor's drawbar tends to lift it instead of pressing it toward the ground), which is highly disadvantageous and can lead to loss of control of the equipment. To address this issue, weight transfer systems have been developed (i.e., systems that lift the front axle, for example), but these do not eliminate the risks of overloading the tractor's hitch components or the spreader's suspension.

Consequently, it would be highly advantageous to find a new technique/approach and/or a system/equipment capable of supporting the load uniformly over terrains with significant slopes and/or obstacles, in order to overcome some of the above-mentioned drawbacks and disadvantages associated with current methods.

### SUMMARY

An object of the present invention is therefore to provide a movement system (e.g., a suspension system and/or another related system, etc.) for a trailer and/or spreader which, due to its design and components, would meet some of the aforementioned needs and thus represent an improvement over other known methods, systems, and/or related load distribution techniques known in the prior art, etc.

The above-mentioned object is achieved, as will be better understood hereinafter, by a movement system (and/or corresponding vehicle(s) equipped with such equipment, etc.) as briefly described in the present description and as illustrated in the accompanying figures.

More specifically, and according to one possible embodiment of the present invention, it is particularly directed to a movement system (and/or a suspension, load distribution system, or other related system, etc.) for a towed vehicle intended to be pulled by a towing vehicle, the movement system comprising:
a set of front wheels adapted to be mounted on a front section of a chassis of the towed vehicle;
a set of rear wheels adapted to be mounted on a subsequent section of the chassis of the towed vehicle;
a movable drawbar adapted to be pivotally mounted relative to the chassis of the towed vehicle and capable of pivoting about at least one corresponding axis of rotation, the drawbar being connectable to a drawbar of the towing vehicle via a hitching device; and
a drive device for actuating the movement of the corresponding axis of rotation of the drawbar relative to the chassis of the towed vehicle, in response to a given travel surface.

According to another aspect of the present invention, it also concerns a corresponding vehicle (e.g., a towed vehicle and/or a towing vehicle) provided with the above-mentioned system and/or equipment.

For example, the present invention may also be directed to a towed vehicle intended to be pulled by a towing vehicle, the towed vehicle comprising:
a chassis having a front section configured to receive a set of front wheels capable of being movable relative to this front section of the chassis, as well as a rear section configured to receive a set of rear wheels capable of being movable relative to this rear section of the chassis;
a movable drawbar adapted to be pivotally mounted relative to the chassis of the towed vehicle, and capable of pivoting about at least one corresponding axis of rotation, the drawbar being connectable to a drawbar of the towing vehicle via a hitching device; and
a drive device for actuating the movement of the corresponding axis of rotation of the drawbar relative to the chassis of the towed vehicle, as well as, selectively, a positioning of the wheels of the towed vehicle relative to its chassis, in response to a given travel surface.

According to another aspect of the present invention, it is also directed to an arrangement of such corresponding vehicles (e.g., a towed vehicle and/or a towing vehicle) equipped with the above-mentioned system and/or equipment.

According to another aspect of the present invention, it is also directed to a kit with corresponding components for assembling the above-mentioned system, equipment, vehicle, and/or arrangement (e.g., with and/or without wheels, since although the final product preferably includes wheels, it is evident to a person skilled in the art that the present technology could ultimately be marketed ‘without wheels,’ prior to the final and/or intended use of the product, etc.).

According to another aspect of the present invention, it is also directed to a method for assembling components of the above-mentioned system, equipment, vehicle, and/or arrangement.

According to another aspect of the present invention, it is also directed to a method of operating the above-mentioned system, equipment, vehicle, and/or arrangement, and/or certain components thereof.

According to another aspect of the present invention, it is also directed to a method of using the above-mentioned system, equipment, vehicle, and/or arrangement, and/or certain components thereof.

According to another aspect of the present invention, it is also directed to a set of components to be interchanged on the above-mentioned system, equipment, vehicle, and/or arrangement.

According to another aspect of the present invention, it is also directed to a method of manufacturing any of the components of the above-mentioned system, equipment, vehicle, and/or arrangement.

According to another aspect of the present invention, it is also directed to a field (and/or the crop harvested therefrom, etc.) having been treated using the above-mentioned system, equipment, vehicle, arrangement, kit, and/or method(s).

According to another aspect of the present invention, it is also directed to a method of doing business involving the above-mentioned system, equipment, vehicle, arrangement, kit, method(s), set, and/or product.

The objects, advantages, and other features of the present invention will become more apparent upon reading the following non-limiting description of preferred embodiments of the invention, shown in the accompanying drawings and provided by way of example only.

### BRIEF DESCRIPTION OF THE ENCLOSED DRAWINGS

FIG. 1 shows the configuration of a multi-axle spreader according to the prior art, where the drawbar is rigidly mounted to the trailer chassis—in this typical case, the connection between the two elements is made by bolting, but in some scenarios, the drawbar may be fully integrated into the chassis by being welded to it.

The following figures illustrate various components, features, variants, and/or possible combinations of different aspects of the present invention, according to different possible embodiments.

For example, FIG. 2 illustrates that displacement elements (e.g., suspension, etc.) according to the present invention may operate independently in order to provide optimal ground contact.

FIG. 3 illustrates a simplified bottom view of a towed vehicle (e.g., spreader) to help understand the assembly of the displacement elements (e.g., suspension, etc.) of the axles.

FIG. 4 illustrates a side view of a towed vehicle (e.g., spreader) to visualize a possible location of the drawbar's axis of rotation.

FIGS. 5 to 10 illustrate, for indicative purposes only, the behavior evolution of a displacement system (e.g., suspension system, etc.) of a towed vehicle when passing over uneven terrain—this evolution is represented in a “comparative” manner between the configuration of a towed vehicle (e.g., trailer) from the prior art and the configuration proposed in the present description, with each figure showing the “upper” portion as the configuration proposed by the present invention and the “lower” portion as the configuration according to the prior art.

FIG. 11 illustrates possible variations of a connection of a movement system (e.g., suspension, etc.) according to the present invention, which may be configured depending on a desired behavior and/or result.

FIG. 12 notably illustrates different axes of rotation at the hitch point of the trailer.

FIG. 13 illustrates an example of a hydraulic connection of a hydraulic suspension system without a movable drawbar, which is capable of being pivotally mounted relative to the chassis of the towed vehicle.

FIG. 14 shows an example of a hydraulic connection of a movement system (e.g., hydraulic suspension, etc.) with a movable drawbar capable of being pivotally mounted relative to the chassis of the towed vehicle, and with at least one wheel axle capable of being moved according to the specific configuration of a given travel surface, according to a particular embodiment of the present invention.

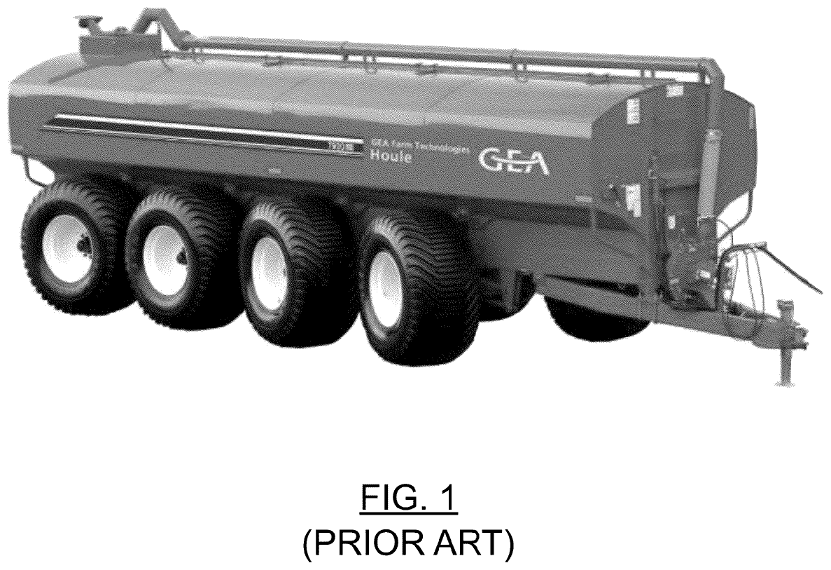

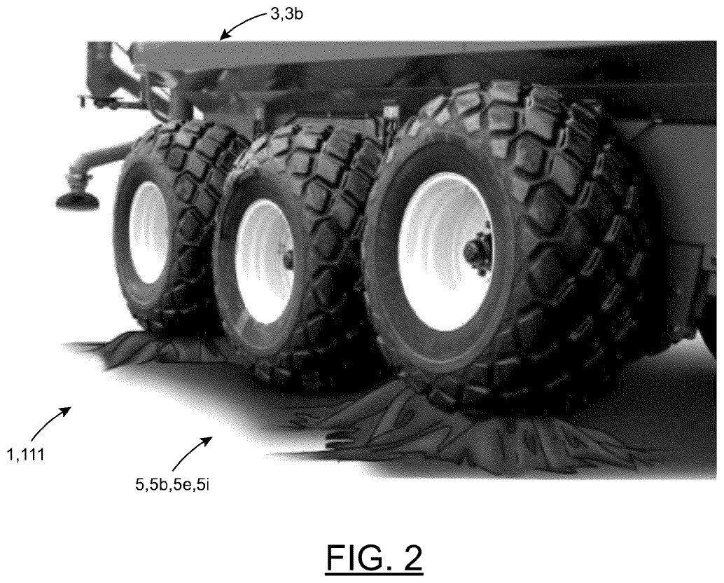

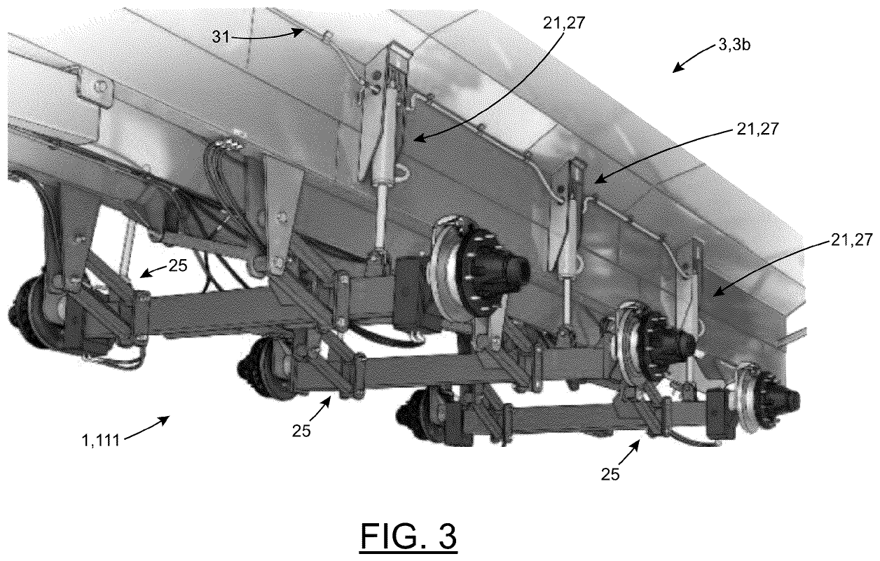

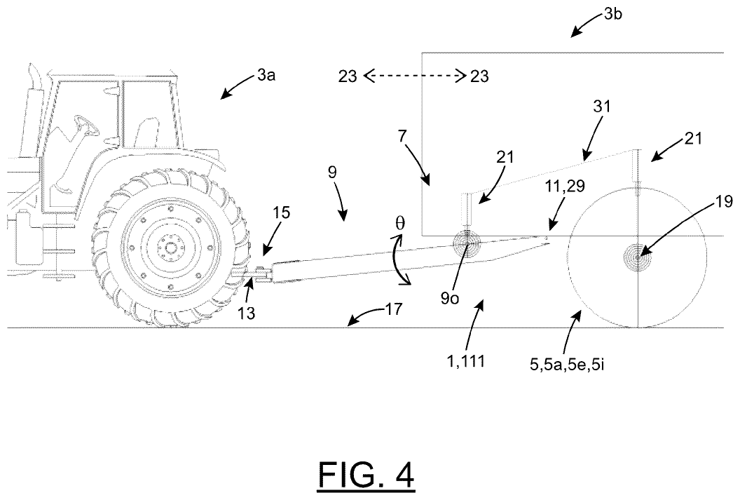

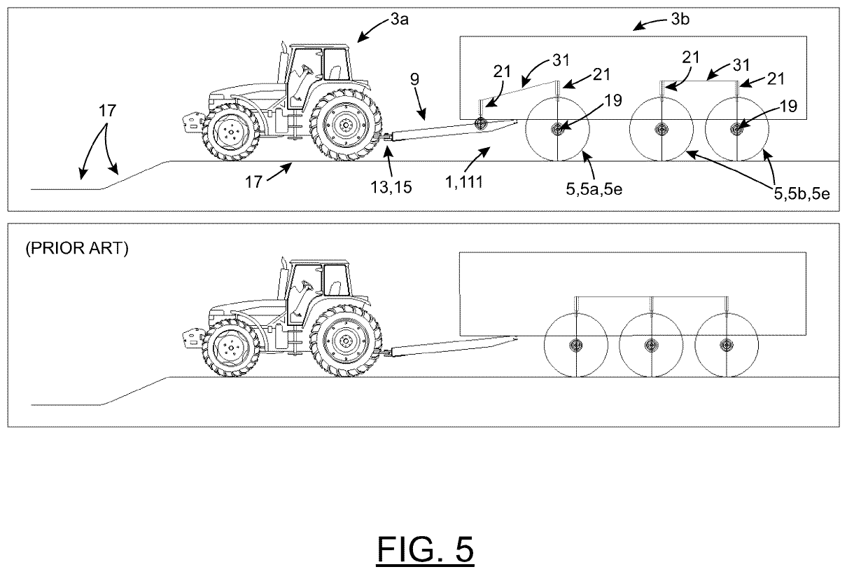

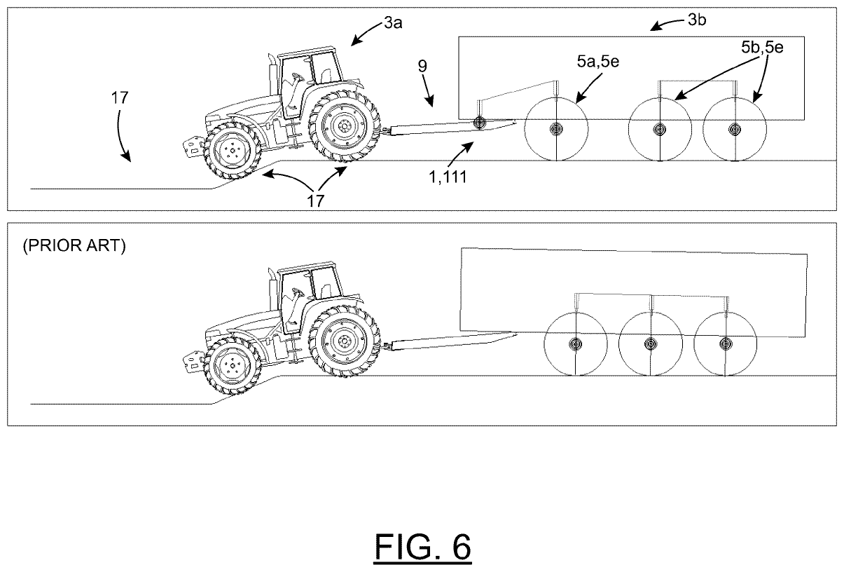

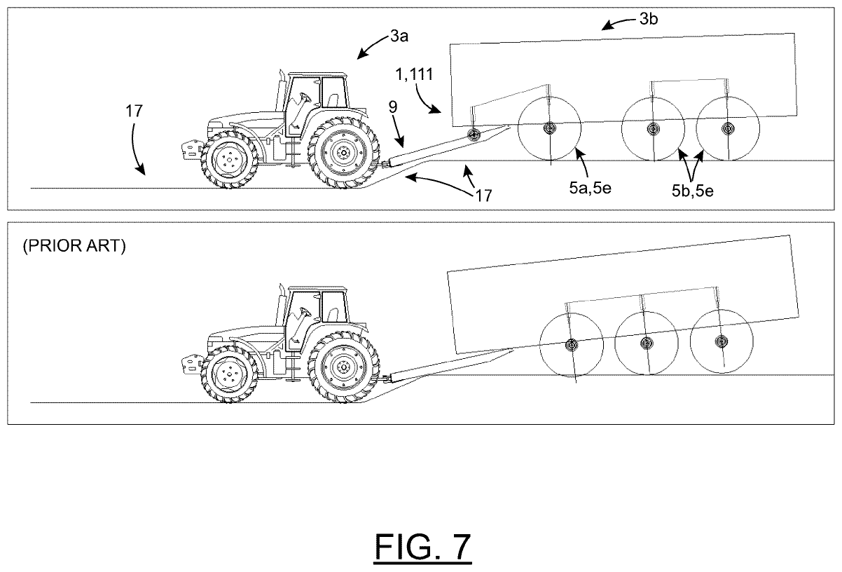

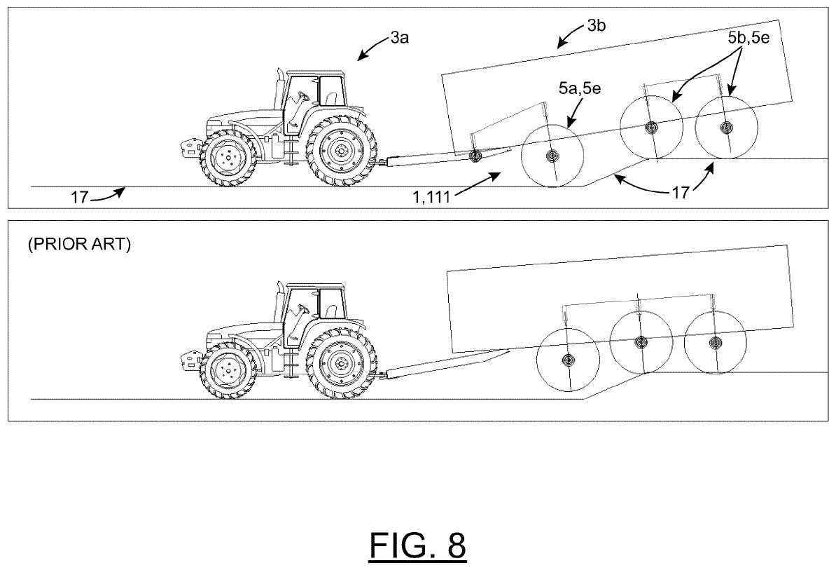

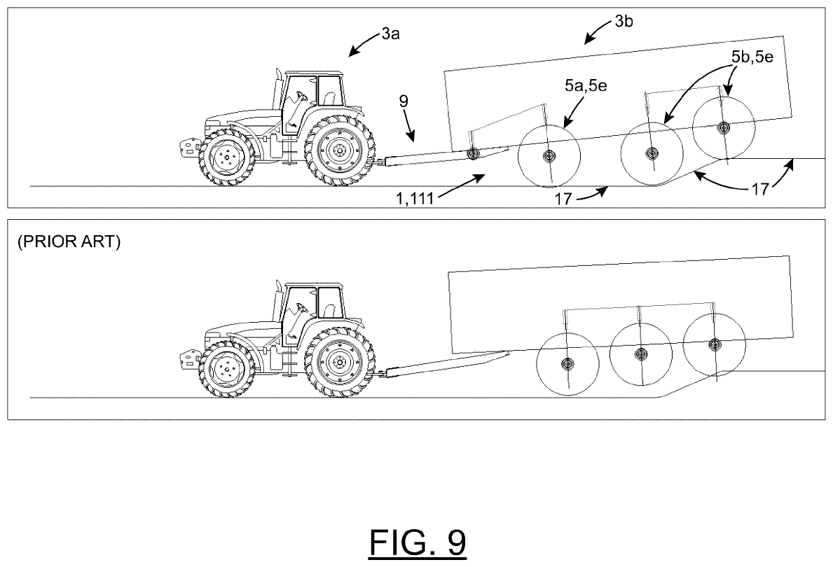

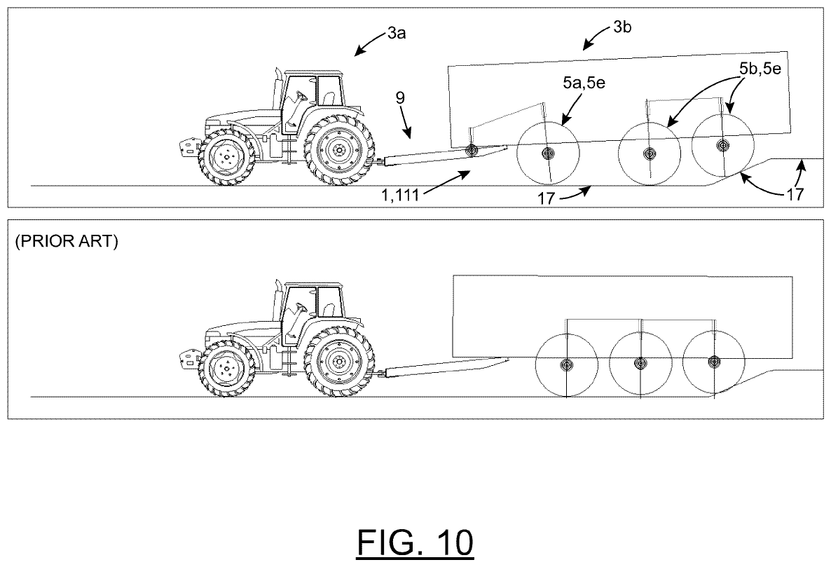

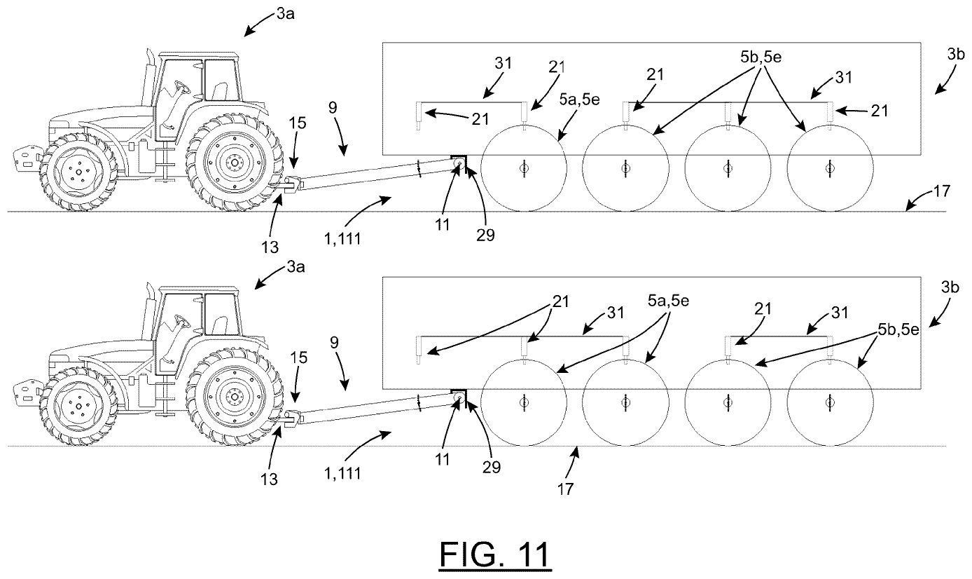

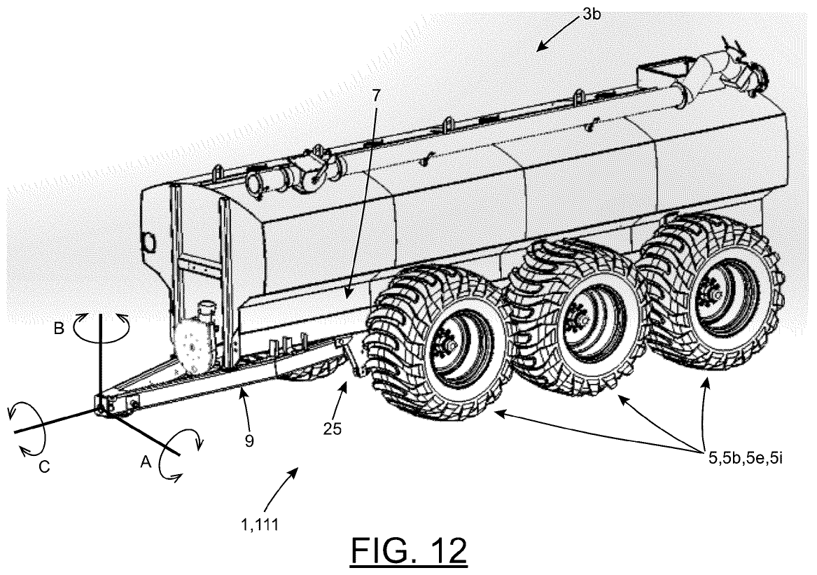

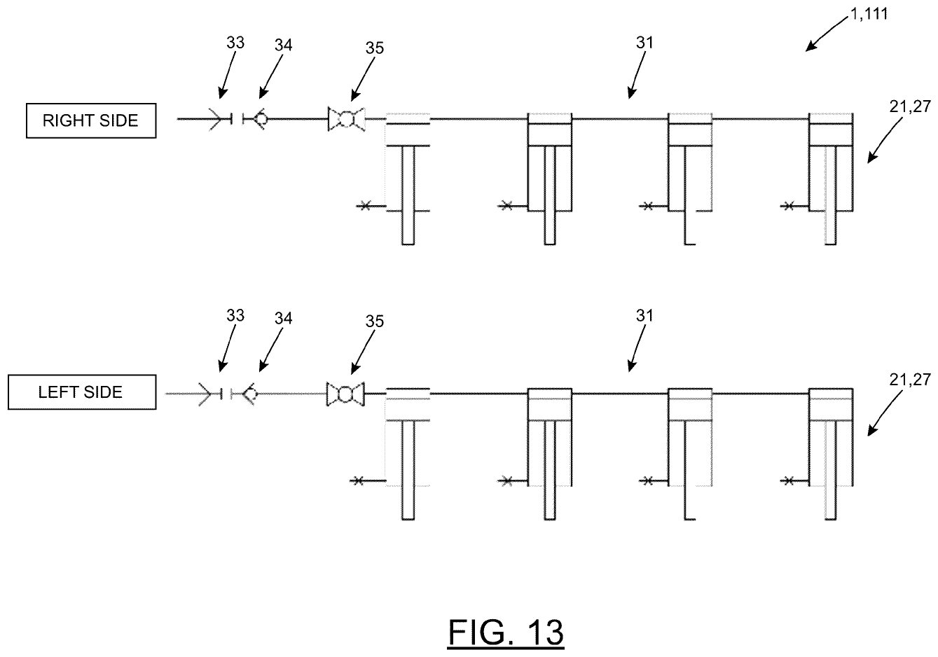

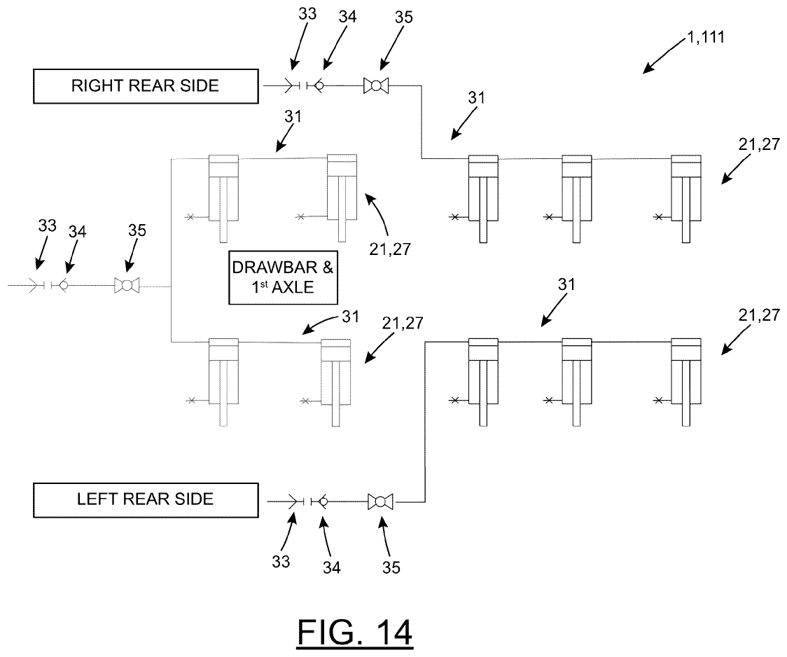

### DETAILED DESCRIPTION OF THE PREFERRED EMBODIMENTS OF THE INVENTION

In the following description, the same reference numerals refer to similar components. The embodiments (geometries, dimensions, etc.) illustrated in the figures and the features described in the application are merely preferred and are provided by way of example only.

Furthermore, although the present invention is primarily designed as a suspension system for a towed vehicle (e.g., a trailer, spreader, etc.) connected to a towing vehicle (e.g., a tractor, etc.), in an agricultural context, for example, the invention could be used with any other type of suspension and/or for any other type of application and/or useful purpose, as would be apparent to a person skilled in the art. Therefore, expressions such as “movement,” “suspension,” “drawbar,” “hitch,” “vehicle,” “towing,” “towed,” “agriculture,” “tractor,” “trailer,” “spreader,” etc., as used herein, and/or any other reference and/or equivalent or similar expression should not be construed as limiting the scope of the present invention and include any other object/substitute and/or any other application with which the present invention can be used and may be useful, as would be evident to a person skilled in the art.

Furthermore, although the preferred embodiments of the system illustrated comprise several components, not all of these components are necessarily essential to the invention and consequently should not be construed in a restrictive sense, i.e., they should not be considered in such a way as to limit the scope of the present invention. It should be understood, as would be evident to a person skilled in the art, that other appropriate components and geometries and/or other possible interactions between them may be used for the system according to the present invention, as will be described below, without departing from the scope of the invention.

Furthermore, expressions such as “system,” “equipment,” “movement,” “suspension,” “drawbar,” “tongue,” “hitch,” “coupling,” “articulation,” “connection,” “connector,” “kit,” “device,” “assembly,” “mechanism,” “product,” “apparatus,” “operator,” “controller,” etc., as well as any other equivalent expression and/or compound words derived from them, may be used interchangeably in the context of this description, as would be apparent to a person skilled in the art. This also applies to other mutually equivalent expressions, such as, for example: a) “hitch,” “connect,” “articulate,” “tow,” “couple,” “anchor,” etc.; b) “vehicle,” “tractor,” “trailer,” “spreader,” etc.; c) “actuator,” “cylinder,” “control,” “movement,” “adjustment,” “suspension,” “damping,” etc.; d) “controller,” “operator,” “robot,” “command,” “computer,” “circuit,” “hardware,” “software,” “mechanical, electronic, and/or computer components,” etc.; as well as any other mutually equivalent expressions related to the aforementioned expressions and/or any other structural and/or functional aspects of the present invention, as would also be evident to a person skilled in the art.

Furthermore, in the context of this description, it should be understood that all elongated objects implicitly have a “longitudinal axis” and/or a “centerline,” such as the longitudinal axis of a rod, for example, or the centerline of a conduit, and that expressions such as “connected” and “capable of being connected,” or “pivoting” and “capable of being pivoted,” can be used interchangeably and are mutually equivalent, as the present invention also concerns a kit with corresponding components to assemble equipment and/or a system fully assembled and operational to implement the present method and/or produce any resulting and/or derived product.

Furthermore, some components of the present system and/or steps of the present method described in this specification may be modified, simplified, omitted, and/or interchanged, without departing from the scope of the present invention, depending on the specific applications for which the present system is designed and/or intended, and also depending on the desired results, as briefly described herein and as would also be evident to a person skilled in the field.

### OVERVIEW OF THE NEW APPROACH PROPOSED BY THE PRESENT

Generally, the present invention, as exemplified in the embodiments given for illustrative purposes only in the attached figures, consists of a wheel movement mechanism that can serve various functions, such as acting as a suspension system (e.g., hydraulic suspension and/or other) for a trailer, combining movable elements on the drawbar and on at least one corresponding axle (for example), when the trailer is hitched to a tractor (also an example), with the goal of ensuring better load distribution on uneven and/or rough terrain, etc.

By adding an articulation to the drawbar, equipping it with actuator(s) (e.g., hydraulic cylinder(s), etc.), and revising the hydraulic connections, it is possible to cross larger obstacles and/or face more significant gradients while maintaining optimal load distribution.

Reading the following paragraphs, in conjunction with the drawings, will provide a better understanding of how the announced advantages are associated with the technical innovations of the invention.

### LIST OF NUMERICAL REFERENCES AND/OR CORRESPONDING PREFERRED COMPONENTS ILLUSTRATED IN THE ATTACHED FIGURES AND/OR POSSIBLE FOR THE PRESENT SYSTEM

1. movement system (and/or damping system, load distribution system, wheel adjustment system, etc.)
2. vehicle
3a. traction vehicle (e.g., tractor, etc.)
3b. towed vehicle (e.g., trailer, spreader, etc.)
5. wheel (e.g., front wheel, rear wheel, effective wheel, independent wheel, and/or other)
5a. front wheel
5b. rear wheel
5e. effective wheel
5i. independent wheel
7. chassis (e.g., of the towed vehicle) drawbar
9o. drawbar-actuator connection (e.g., pivot, etc.)
11. rotation axis (of the drawbar)
13. hitch bar
15. hitching device
17. given movement surface
19. axle(s)
21. actuator (of the movement system—e.g., hydraulic cylinder)
23. longitudinal movement axis (e.g., of the towed vehicle)
25. support arm assembly
27. suspension device
29. connection device
31. hydraulic circuit (of the movement system)
33. connection to tractor (e.g., hydraulic connection)
34. quick connector (e.g., quick hydraulic connector)
35. valve (e.g., hydraulic valve)
111. drive device (of the movement system)
A. first degree of freedom (e.g., rotation axis—pitch adjustment)
B. second degree of freedom (e.g., rotation axis—yaw adjustment)
C. third degree of freedom (e.g., rotation axis—roll adjustment)
Θ. drawbar movement (e.g., rotational, angular movement, etc.)

The present movement system (e.g., suspension system, damping system, load distribution system, wheel adjustment system and/or other possible function(s) and/or application(s), etc.) (and its various inventive aspects) may take shape in different forms and/or embodiments, comprising one and/or more of the following components and characteristics (and/or various combination(s) and/or permutation(s) thereof), provided as preferred and/or optional embodiment(s) only:
i.) A movement system (and/or a suspension system, load distribution system and/or other, etc.) for a towed vehicle intended to be pulled by a traction vehicle, the movement system comprising:
a series of front wheels suitable for being mounted on a front section of a chassis of the towed vehicle;
a series of rear wheels suitable for being mounted on a subsequent section (e.g., a rear, middle and/or other section) of the chassis of the towed vehicle; a movable drawbar suitable for being pivotally mounted relative to the chassis of the towed vehicle, and suitable for pivoting around at least one corresponding axis of rotation, the drawbar being connectable to a hitch bar of the traction vehicle by means of a hitching device; and
a drive device for driving in movement (e.g., vertical movement and/or other) the corresponding axis of rotation of the drawbar relative to the chassis of the towed vehicle, in response to a given movement surface.
ii.) A movement system according to any of the preceding combinations, wherein the drive device is further configured to drive in movement (e.g., vertical movement and/or other) at least one effective wheel of said wheels of the movement system relative to the chassis of the towed vehicle, in response to a corresponding topology of the given movement surface.
iii.) A movement system according to any of the preceding combinations, wherein said at least one effective wheel of the movement system is capable of being positioned (e.g., in height, in distance, etc.) relative to the chassis of the towed vehicle, in response to the corresponding topology of the given movement surface.
iv.) A movement system according to any of the preceding combinations, wherein said at least one effective wheel of the movement system is operatively connectable (e.g., hydraulically, mechanically, electronically and/or otherwise, whether directly and/or indirectly, etc.) to the drive device, and wherein said at least one effective wheel of the movement system is capable of being moved via the drive device (e.g., in response to a corresponding movement of the drawbar, and/or in response to a corresponding topology “detected” by the traction vehicle and/or by the towed vehicle during a corresponding movement, etc.).
v.) A movement system according to any of the preceding combinations, wherein a given movement of the drawbar causes a corresponding inverse movement of said at least one effective wheel of the movement system (e.g., a “raising” of the drawbar causes a “lowering” of said at least one effective wheel, and a “lowering” of the drawbar causes a “raising” of said at least one effective wheel).
vi.) A movement system according to any of the preceding combinations, wherein the drive device comprises at least one first actuator (e.g., controller, device, lever, and/or etc.) to adjust (e.g., control, modify, change, correct, etc.) a positioning (e.g., vertical positioning and/or other) of the axis of rotation of the drawbar relative to the chassis of the towed vehicle.
vii.) A movement system according to any of the preceding combinations, wherein the drive device comprises at least one second actuator (e.g., controller, device, lever, and/or etc.) to adjust (e.g., control, modify, change, correct, etc.) a positioning (e.g., vertical positioning and/or other) of said at least one effective wheel relative to the chassis of the towed vehicle.
viii.) A movement system according to any of the preceding combinations, wherein at least one given actuator (e.g., said first actuator(s) and/or said second actuator(s)) is capable of being operatively disposed (e.g., hydraulically, mechanically, electronically and/or otherwise, whether directly and/or indirectly, etc.) between a given part (e.g., fixed part, and/or other, etc.) of the chassis of the towed vehicle and an axle of said at least one effective wheel of the movement system.
ix.) A movement system according to any of the preceding combinations, wherein said at least one first actuator and said at least one second actuator are interconnected with one another.
x.) A movement system according to any of the preceding combinations, wherein a given pair of actuators of the movement system comprises at least one proactive actuator and at least one reactive actuator (e.g., said at least one first actuator may comprise at least one proactive actuator and said at least one second actuator may comprise at least one reactive actuator, and/or vice versa).
xi.) A movement system according to any of the preceding combinations, wherein said given pair of actuators comprises hydraulic cylinders that are part of a same hydraulic circuit (e.g., said at least one first actuator and said at least one second actuator may comprise hydraulic cylinders that are part of the same hydraulic circuit, etc.—it should be noted that any other different and/or advantageous arrangement is also conceivable with the present movement system, as will be evident to a person skilled in the art).
xii.) A movement system according to any of the preceding combinations, wherein each actuator is a hydraulic cylinder.
xiii.) A movement system according to any of the preceding combinations, wherein the axis of rotation of the drawbar is arranged transversely with respect to a longitudinal axis of movement of the chassis of the towed vehicle.
xiv.) A movement system according to any of the preceding combinations, wherein said at least one effective wheel comprises at least one wheel that is pivotable with respect to at least one corresponding axle arranged substantially parallel to the axis of rotation of the drawbar.
xv.) A movement system according to any of the preceding combinations, wherein said at least one corresponding axle is movable relative to the chassis of the towed vehicle via a set of support arms having pivoting ends.
xvi.) A movement system according to any of the preceding combinations, wherein said at least one effective wheel comprises at least one front wheel that is pivotable with respect to at least one corresponding front axle.
xvii.) A movement system according to any of the preceding combinations, wherein said at least one effective wheel comprises at least one pair of front wheels.
xviii.) A movement system according to any of the preceding combinations, wherein said at least one effective wheel comprises at least one pair of front wheels that are pivotable with respect to at least one same corresponding front axle.
xix.) A movement system according to any of the preceding combinations, wherein said at least one effective wheel comprises at least one pair of front wheels each being pivotable with respect to at least one given corresponding front axle.
xx.) A movement system according to any of the preceding combinations, wherein said at least one effective wheel comprises at least two corresponding pairs of front wheels.
xxi.) A movement system according to any of the preceding combinations, wherein said at least one effective wheel comprises at least one rear wheel that is pivotable with respect to at least one corresponding rear axle.
xxii.) A movement system according to any of the preceding combinations, wherein said at least one effective wheel comprises at least one pair of rear wheels.
xxiii.) A movement system according to any of the preceding combinations, wherein said at least one effective wheel comprises at least one pair of rear wheels that are pivotable with respect to at least one same corresponding rear axle.
xxiv.) A movement system according to any of the preceding combinations, wherein said at least one effective wheel comprises at least one pair of rear wheels, each being pivotable with respect to at least one given corresponding rear axle.
xxv.) A movement system according to any of the preceding combinations, wherein said at least one effective wheel comprises at least two corresponding pairs of rear wheels.
xxvi.) A movement system according to any of the preceding combinations, wherein said at least one effective wheel comprises at least three corresponding pairs of rear wheels.
xxvii.) A movement system according to any of the preceding combinations, wherein at least one independent wheel of the movement system is capable of moving freely (e.g., in height, independently from other wheels and/or from a main drive system and/or a corresponding circuit, etc.) relative to the chassis of the towed vehicle.
xxviii.) A movement system according to any of the preceding combinations, wherein said at least one independent wheel is a side wheel (e.g., left side and/or right side of the chassis, and/or of any other component) of the movement system.
xxix.) A movement system according to any of the preceding combinations, wherein said at least one independent wheel is found among at least one of the two series of wheels (e.g., series of front wheels and/or series of rear wheels).
xxx.) A movement system according to any of the preceding combinations, wherein said at least one independent wheel comprises a plurality of independent wheels.
xxxi.) A movement system according to any of the preceding combinations, wherein said plurality of independent wheels comprises at least one left independent wheel and at least one right independent wheel.
xxxii.) A movement system according to any of the preceding combinations, wherein said at least one left independent wheel and said at least one right independent wheel are found among the series of rear wheels, and wherein said at least one left independent wheel is movable independently from said at least one right independent wheel (and vice versa).
xxxiii.) A movement system according to any of the preceding combinations, wherein said plurality of independent wheels comprises a plurality of left independent wheels and a plurality of right independent wheels.
xxxiv.) A movement system according to any of the preceding combinations, wherein each independent wheel is connected to a corresponding hydraulic circuit.
xxxv.) A movement system according to any of the preceding combinations, wherein each independent wheel on the same side (e.g., left side and/or right side of the chassis of the towed vehicle) is movable independently from another independent wheel on that same side.
xxxvi.) A movement system according to any of the preceding combinations, wherein the series of front wheels is interconnected with the series of rear wheels via the same drive system.
xxxvii.) A movement system according to any of the preceding combinations, wherein the series of front wheels is drivable independently from the series of rear wheels.
xxxviii.) A movement system according to any of the preceding combinations, wherein each wheel series is equipped with a corresponding hydraulic circuit.
xxxix.) A movement system according to any of the preceding combinations, wherein the front wheel series is interconnectable via a first hydraulic circuit, and wherein the rear wheel series is interconnectable via a second hydraulic circuit that is distinct (e.g., separate, different, etc.) from the first hydraulic circuit.
xl.) A movement system according to any of the preceding combinations, wherein the drive system is configured to cooperate with the first hydraulic circuit.
xli.) A movement system according to any of the preceding combinations, wherein said at least one effective wheel of the movement system is capable of being equipped with at least one corresponding suspension (and/or damping) device.
xlii.) A movement system according to any of the preceding combinations, wherein at least one wheel other than said at least one effective wheel of the movement system is also capable of being equipped with at least one corresponding suspension (and/or damping) device.
xliii.) A movement system according to any of the preceding combinations, wherein each wheel of the movement system is capable of being equipped with at least one corresponding suspension (and/or damping) device.
xliv.) A movement system according to any of the preceding combinations, wherein the movement system acts as a suspension (and/or damping) system for the towed vehicle.
xlv.) A movement system according to any of the preceding combinations, wherein the towed vehicle is a trailer or a spreader (and/or any other given/appropriate type of vehicle).
xlvi.) A movement system according to any of the preceding combinations, wherein the traction vehicle is a tractor.
xlvii.) A movement system according to any of the preceding combinations, wherein the hitch device is configured to allow adjustment along at least one degree of freedom.
xlviii.) A movement system according to any of the preceding combinations, wherein the hitch device is configured to allow pitch adjustment.
xlix.) A movement system according to any of the preceding combinations, wherein the hitch device is configured to allow yaw adjustment.

l.) A movement system according to any of the preceding combinations, wherein the hitch device is configured to allow roll adjustment.
li.) A movement system according to any of the preceding combinations, wherein the hitch device is a hitch device such as the one described in patent application no. PCT/CA2022/051243 dated Aug. 16, 2022 (for example, the content of this application being fully and/or selectively incorporated by reference).
lii.) A movement system according to any of the preceding combinations, wherein the drawbar is configured to allow a movement (e.g., tilting, pivoting, rotation, up/down, extension/contraction, etc.) along at least one degree of freedom.
liii.) A movement system according to any of the preceding combinations, wherein the drawbar is connectable to the chassis of the towed vehicle by means of a corresponding connection device (e.g., rivet(s), bolt(s) and/or nut(s), rod(s) and/or pin(s), etc.).
liv.) A movement system according to any of the preceding combinations, wherein at least one corresponding suspension (and/or damping) device is operatively disposed (e.g., hydraulically, mechanically, electronically and/or otherwise, either directly and/or indirectly, etc.) between the rotation axis of the drawbar and said at least one effective wheel of said wheels of the movement system.

lv.) A kit with corresponding components to assemble a movement system according to any of the preceding combinations.

lvi.) A towed vehicle equipped with a movement system according to any of the preceding combinations.
lvii.) A combination of a towed vehicle being pulled by a traction vehicle by means of a hitch device, the towed vehicle being equipped with a movement system according to any of the preceding combinations.
lviii.) A method for moving a towed vehicle on a given travel surface, the method comprising the steps of:
a) providing a towed vehicle equipped with a movement system according to any one of the preceding combinations;
b) connecting the drawbar of the towed vehicle to the hitch bar of a traction vehicle via a hitch device; and
c) driving the drawbar's axis of rotation in vertical movement relative to the chassis of the towed vehicle, in response to a positioning of at least one effective wheel of said wheels, during a displacement of the towed vehicle via its wheels on said given travel surface.

Naturally, several modifications and/or other alternatives and/or other technical/mechanical equivalents could be made to the present system and/or its components and/or corresponding steps, without departing from the present invention, as is evident to a person skilled in the art.

Notably, and as previously mentioned, the present movement system may serve as an “other” system (e.g., suspension, damping, load distribution, etc.) for a trailer (for example), and thus, the various aspects of this system may also take different forms and/or expressions, comprising one and/or several of the following components and characteristics (and/or different combinations and/or permutations thereof), provided as preferential and/or optional embodiments only:
i.) A hitch system for linking a traction vehicle and a towed vehicle, the hitch system comprising:
a main connection assembly being positioned, formed, and dimensioned to receive a portion of a hitch bar of the traction vehicle (commonly called hitch hand);
a main connection assembly operatively linking the hitch bar of the traction vehicle and the hitch hand of the trailer;
a main connection assembly at the level of the hitch hand providing the possibility and amplitude of rotational movement along the three axes: pitch, roll, and yaw.
ii.) A connection system linking the drawbar to the chassis of the spreader, the system comprising:
a support assembly(ies) being fixedly connected to the chassis of the spreader and located in front of the first axle of the spreader;
a fixed support assembly(ies) providing one or more openings to accommodate the mounting axis or axes of the drawbar.
iii.) A connection system in which the items described above are operatively linked by means of at least one fastener (e.g., rivet, bolt and nut, rod and pin, etc.) while allowing the drawbar to rotate relative to the transverse axis of the spreader.
iv.) A hydraulic cylinder system to limit and control the position of the drawbar, the hydraulic system comprising:
a cylinder support assembly fixedly attached to the chassis of the spreader; and
a cylinder support assembly fixedly attached to the drawbar; a cylinder support assembly located between the system connecting the drawbar to the chassis of the spreader and the hitch system to the tractor;
a hydraulic cylinder assembly whose ends are operatively linked to the supports using at least one fastener (e.g., bolt and nut, rod and pin).
v.) A multi-axle system on which a hydraulic suspension system is installed, the hydraulic suspension system comprising:
a cylinder support assembly fixedly attached to the chassis of the spreader; and
a cylinder support assembly fixedly attached to the axle;
a hydraulic cylinder assembly whose ends are operatively linked to the supports using at least one fastener (e.g., bolt and nut, rod and pin).
vi.) A first hydraulic connection system linking the rear axles of the spreader, the hydraulic system comprising:
a set of hydraulic conduits and fittings linking the different suspension cylinders together;
a set of hydraulic hoses, fittings, and quick-connectors allowing connection to the hydraulic outlets of the traction vehicle. This connection allows adjustment of the suspension height of the targeted axle group by injecting or removing oil;
a set of manual valves located between the quick connector connecting to the traction vehicle and the cylinder. The valve allows the creation of a closed hydraulic system for the suspension elements and the purging of residual pressure from the hydraulic lines between the valve and the traction vehicle;
a hydraulic connection method allowing individual control of the right and left sides of the suspension elements.
vii.) A second hydraulic connection system linking the front axle(s) of the spreader and the drawbar cylinder(s), the hydraulic system comprising:
a set of hydraulic conduits and fittings linking the different suspension cylinders together;
a set of hydraulic hoses, fittings, and quick connectors allowing connection to the hydraulic outlets of the traction vehicle. This connection (piston side of the cylinders) allows the height of the suspension of the targeted axle group to be adjusted by injecting or removing oil;
a set of manual valves located between the quick connector connecting to the traction vehicle and the cylinder. Valve allowing the creation of a closed hydraulic system for the suspension elements and the purging of residual pressure from the hydraulic conduits between the valve and the traction vehicle;
a hydraulic connection method allowing individual control of the right and left sides of the suspension elements.
viii.) A load distribution system for a towed vehicle hitched to a traction vehicle, the load distribution system comprising:
a multi-axle wheel assembly;
a set of movable drawbars;
a first hydraulic suspension assembly where the front axle(s) are connected with the movable drawbar;
a second hydraulic suspension assembly where the right-side rear axles are interconnected;
a third hydraulic suspension assembly where the left-side rear axles are interconnected.
ix.) A load distribution system according to any one of the preceding combinations, wherein the set of movable drawbars comprises:
a drawbar-to-chassis connection assembly of the towed vehicle allowing rotation about the transverse axis of said towed vehicle;
a drawbar-to-hitch bar connection system of the traction vehicle allowing rotation along three axes: pitch, roll, and yaw.
x.) A load distribution system according to any one of the preceding combinations, on which a hydraulic cylinder system is assembled to ensure the positioning and/or blocking of the drawbar's movement relative to the chassis of the towed vehicle.
xi.) A drawbar system according to any one of the preceding combinations, on which the hydraulic circuit of the drawbar's hydraulic cylinder allows coupling with the suspension cylinders of the front axle(s) of the towed vehicle.
xii.) A towed vehicle according to any one of the preceding combinations, where the hydraulic connection of the rear axle suspension elements is isolated from the suspension elements of the drawbar and front axle(s).
xiii.) A suspension system for a towed vehicle (e.g., trailer, spreader, etc.), the towed vehicle being attachable to a traction vehicle by a hitch system, the suspension system comprising:
a chassis;
a wheel assembly fixed to said chassis, the wheel assembly comprising a plurality of axles;
a drawbar removably attached to said chassis;
a first (hydropneumatic) suspension assembly linking the drawbar and a first axle group, the first axle group comprising at least one front axle;
a second (hydropneumatic) suspension assembly linking a second axle group, the second axle group comprising at least one rear axle.
xiv.) The suspension system according to any one of the preceding combinations, in which the first and second suspension assemblies are mechanically decoupled.
xv.) The suspension system according to any one of the preceding combinations, in which the drawbar is pivotally attached to the chassis (e.g., rivet, bolt and nut, rod and pin, etc.).
xvi.) The suspension system according to any one of the preceding combinations, in which at least one of the first and second suspension assemblies is a hydraulic suspension assembly (using a hydraulic fluid, e.g., based on synthetic esters, mineral oils, vegetable oils, etc.).
xvii.) The suspension system according to any one of the preceding combinations, in which the first suspension assembly comprises a set of hydraulic cylinders having a first end operatively fixed to the chassis and a second end operatively fixed to the drawbar.
xviii.) The suspension system according to any one of the preceding combinations, in which each of the first and second suspension assemblies comprises at least one set of hydraulic cylinders having a first end operatively fixed to the chassis and a second end operatively fixed to an axle.
xix.) The suspension system according to any one of the preceding combinations, in which each of the first and second suspension assemblies comprises a left suspension element and a right suspension element operatively fixed to an axle.
xx.) The suspension system according to any one of the preceding combinations, in which the drawbar comprises a first coupling of the hitch system.
xxi.) The suspension system according to any one of the preceding combinations, in which the set of hydraulic cylinders is fixed to the drawbar at a point along said drawbar between the first coupling and a pivot point of said drawbar.
xxii.) The suspension system according to any one of the preceding combinations, in which the first coupling is formed and dimensioned to receive at least a portion of a hitch bar of the traction vehicle.
xxiii.) The suspension system according to any one of the preceding combinations, in which the first suspension assembly comprises a first hydraulic circuit interconnecting one or more hydraulic cylinders of said first suspension assembly.
xxiv.) The suspension system according to any one of the preceding combinations, in which the second suspension assembly comprises a second hydraulic circuit interconnecting one or more hydraulic cylinders of said second suspension assembly.
xxv.) The suspension system according to any one of the preceding combinations, in which the first and second hydraulic circuits comprise one or more hydraulic hoses, fittings, etc., interconnecting the hydraulic cylinders of each of the first and second suspension assemblies.
xxvi.) The suspension system according to any one of the preceding combinations, in which at least one of the first and second hydraulic circuits is adapted to be fluidly connected to a hydraulic circuit of the traction vehicle (the hydraulic circuit of the traction vehicle being preferably pressurized).
xxvii.) The suspension system according to any one of the preceding combinations, in which each of the first and second suspension assemblies comprises a hydraulic connector adapted to connect one of the first and second hydraulic circuits to the hydraulic circuit of the traction vehicle.
xxviii.) The suspension system according to any one of the preceding combinations, in which at least one of the first and second hydraulic circuits comprises a valve adapted to selectively fluidically isolate the first or the second hydraulic circuit.
xxix.) The suspension system according to any one of the preceding combinations, in which at least one of the first and second hydraulic circuits is fluidically isolated from the hydraulic circuit of the traction vehicle.
xxx.) The suspension system according to any one of the preceding combinations, in which the valve is located downstream of the hydraulic connector.
xxxi.) The suspension system according to any one of the preceding combinations further comprising one or more manual controls.
xxxii.) The suspension system according to any one of the preceding combinations further comprising one or more hydraulic controls.
xxxiii.) The suspension system according to any one of the preceding combinations, in which one or more hydraulic controls are adapted to control the valve.
xxxiv.) The suspension system according to any one of the preceding combinations, in which at least one of the first and second hydraulic circuits comprises a left hydraulic circuit and a right hydraulic circuit, the left and right hydraulic circuits being fluidically separated.
xxxv.) The suspension system according to any one of the preceding combinations, in which the second suspension assembly is positioned on the towed vehicle downstream of the first suspension assembly with respect to a direction defined by a forward movement of the traction vehicle.
xxxvi.) The suspension system according to any one of the preceding combinations, in which each of the first and second suspension assemblies comprises a hydraulic fluid, the hydraulic fluid being one of water-based hydraulic fluids, petroleum-based hydraulic fluids, and synthetic hydraulic fluids.
xxxvii.) The suspension system according to any one of the preceding combinations, in which the hitch system comprises at least one of a pitch adjustment assembly, a yaw adjustment assembly, and a roll adjustment assembly.
xxxviii.)A suspension system for a towed vehicle, the towed vehicle being attachable to a traction vehicle via a hitch system, the suspension system comprising:
a chassis;

a running gear assembly fixed to said chassis, the running gear assembly comprising a plurality of axles;
a drawbar pivotally attached to said chassis;
a first hydraulic suspension assembly connecting the drawbar and a first group of axles, the first hydraulic suspension assembly comprising a first hydraulic circuit;
a second hydraulic suspension assembly connecting a second group of axles, the second hydraulic suspension assembly comprising a second hydraulic circuit; wherein the first and second hydraulic suspension assemblies are mechanically decoupled; and
wherein at least one of the first and second hydraulic circuits is adapted to be fluidically connected to a hydraulic circuit of the traction vehicle.
xxxix.) A towed vehicle equipped with the suspension system according to any one of the preceding combinations.
xl.) A method for connecting a towed vehicle to a traction vehicle, the traction vehicle being equipped with a pressurized hydraulic circuit, the method comprising:
attaching a first coupling of a pivoting drawbar of the towed vehicle to a second coupling of the traction vehicle;
fluidically connecting a first hydraulic circuit of the towed vehicle to the pressurized hydraulic circuit of the traction vehicle, the first hydraulic circuit being connected to a first suspension assembly adapted to dampen a movement of the pivoting drawbar; and
fluidically connecting a second hydraulic circuit of the towed vehicle to the pressurized hydraulic circuit of the traction vehicle.
xli.) The method according to any one of the preceding combinations further comprising regulating the flow of hydraulic fluid between at least one of the first and second hydraulic circuits of the towed vehicle and the pressurized hydraulic circuit of the traction vehicle.
xlii.) The method according to any one of the preceding combinations, wherein the step of fluidically connecting the first hydraulic circuit of the towed vehicle to the pressurized hydraulic circuit of the traction vehicle includes a step of connecting a first left hydraulic circuit and a first right hydraulic circuit to the pressurized hydraulic circuit.
xliii.) The method according to any one of the preceding combinations, wherein the step of fluidically connecting the second hydraulic circuit of the towed vehicle to the pressurized hydraulic circuit of the traction vehicle includes the step of connecting a second left hydraulic circuit and a second right hydraulic circuit to the pressurized hydraulic circuit.
xliv.) A suspension element (e.g., coil springs, leaf springs, torsion bar, hydropneumatic, etc.) for a towed vehicle (e.g., trailer, spreader, etc.), the towed vehicle comprising a removable drawbar attachable to a traction vehicle via a hitch system, the suspension element comprising:
a first end operatively fixed to a chassis of the towed vehicle; and
a second end operatively fixed to the removable drawbar;
wherein the suspension element is operatively coupled to one of a plurality of suspension assemblies of the towed vehicle.
xlv.) The suspension element according to any one of the preceding combinations, wherein the second end is fixed to the drawbar at a point along said drawbar between a drawbar coupling and a pivot point of the drawbar.
xlvi.) A method for distributing a load of a towed vehicle over a plurality of suspension assemblies, the method comprising:
distributing a load exerted on a removable drawbar of the vehicle and at least a first axle of the towed vehicle over a first suspension assembly; and
distributing a load exerted on a second axle of the towed vehicle over a second suspension assembly.
xlvii.) The method according to any one of the preceding combinations, wherein distributing the load exerted on the second axle comprises distributing the load exerted on the second axle over a second left suspension assembly and over a second right suspension assembly.

As can now be better appreciated in view of the foregoing, the present invention is particularly advantageous in that, among several other benefits, it allows for a greater range of movement due to the addition of an articulation at the drawbar. In combination with the drawbar's articulation, the proposed hydraulic connection of the present displacement system (e.g., suspension system and/or otherwise) advantageously enables the effective and uniform distribution of load across the various axles throughout this new range of movement, etc.

Finally, and according to the present invention, the displacement equipment (and/or resulting system, etc.) and its corresponding components are preferably made of substantially rigid materials, such as metallic materials (stainless steel, titanium, etc.), hardened polymers, composite materials, and/or any other suitable material, while the other components of the system according to the present invention, in order to obtain the benefits discussed above, may be made of any other appropriate material, such as polymeric materials (plastic, rubber, etc.), and/or any other suitable material, depending on the specific applications for which the system is designed and the different parameters involved, as would be evident to a person skilled in the art.

Although the present invention has been previously explained through preferred embodiments thereof, it must be specified that any modification to these preferred embodiments is not considered to change or alter the nature and scope of the present invention. In fact, the appended claim(s) must not be limited in scope by the preferred embodiments illustrated in the examples, but must receive the broadest possible interpretation that is consistent with the overall description.

1. A displacement system for a towed vehicle intended to be pulled by a towing vehicle, the displacement system comprising:
a series of front wheels adapted to be mounted on a front section of a chassis of the towed vehicle;
a series of rear wheels adapted to be mounted on a subsequent section of the chassis of the towed vehicle;
a movable drawbar adapted to be pivotally mounted with respect to the chassis of the towed vehicle, and adapted to pivot about at least one corresponding axis of rotation, the drawbar being connectable to a hitch bar of the towing vehicle via a hitching device; and
a drive device for driving the corresponding axis of rotation of the drawbar in displacement with respect to the chassis of the towed vehicle, in response to a given displacement surface.

2. A displacement system according to claim 1, wherein the drive device is further configured to drive at least one effective wheel of said wheels of the displacement system in displacement with respect to the chassis of the towed vehicle, in response to a corresponding topology of the given displacement surface.

3-4. (canceled)

5. A displacement system according to claim 2, wherein a given movement of the drawbar causes a corresponding inverse movement of said at least one effective wheel of the displacement system.

6. A displacement system according to claim 2, wherein the drive device comprises at least one first actuator for adjusting a positioning of the axis of rotation of the drawbar with respect to the chassis of the towed vehicle.

7. A displacement system according to claim 6, wherein the drive device comprises at least one second actuator for adjusting a positioning of said at least one effective wheel with respect to the chassis of the towed vehicle.

8. (canceled)

9. A displacement system according to claim 7, wherein said at least one first actuator and said at least one second actuator are interconnected with one another.

10. A displacement system according to claim 7, wherein a given pair of actuators of the displacement system comprises at least one proactive actuator and at least one reactive actuator.

11. A displacement system according to claim 10, wherein the first and second actuators are hydraulic cylinders that are part of the same hydraulic circuit.

12-13. (canceled)

14. A displacement system according to claim 2, wherein said at least one effective wheel comprises at least one wheel that is pivotable relative to at least one corresponding axle arranged substantially parallel to the axis of rotation of the drawbar (9).

15. A displacement system according to claim 14, wherein said at least one corresponding axle is adapted to be moved relative to the chassis of the towed vehicle via a set of support arms having pivoting ends.

16-18. (canceled)

19. A displacement system according to claim 2, wherein said at least one effective wheel comprises at least one pair of front wheels, each being pivotable relative to at least one given corresponding front axle.

20. (canceled)

21. A displacement system according to claim 2, wherein said at least one effective wheel comprises at least one rear wheel that is pivotable relative to at least one corresponding rear axle.

22-23. (canceled)

24. A displacement system according to claim 2, wherein said at least one effective wheel comprises at least one pair of rear wheels, each being pivotable relative to at least one given corresponding rear axle.

25-26. (canceled)

27. A displacement system according to claim 1, wherein at least one independent wheel of the displacement system is adapted to move freely relative to the chassis of the towed vehicle.

28-32. (canceled)

33. A displacement system according to claim 27, wherein said plurality of independent wheels comprises a plurality of left independent wheels and a plurality of right independent wheels.

34. A displacement system according to claim 27, wherein each of the plurality of independent wheels is connected to a corresponding hydraulic circuit (31).

35-37. (canceled)

38. A displacement system according to claim 1, wherein each of the series of front and rear wheels is provided with a corresponding hydraulic circuit.

39. A displacement system according to claim 1, wherein the series of front wheels is interconnectable through a first hydraulic circuit, and wherein the series of rear wheels is interconnectable through a second hydraulic circuit that is distinct from the first hydraulic circuit.

40. A displacement system according to claim 39, wherein the drive device is configured to cooperate with the first hydraulic circuit.

41-43. (canceled)

44. A displacement system according to claim 1, wherein the displacement system acts as a suspension system for the towed vehicle.

45-58. (canceled)
